(19) United States
(12) Patent Application Publication
(10) Pub. No.: US 2002/0022671 A1
(43) Pub. Date: Feb. 21, 2002

(54) Sulfonation process

(76) Inventors: Reinhold Klipper, Koln (DE); Rudolf Wagner, Koln (DE); Rudiger Seidel, Leverkusen (DE); Holger Lutjens, Koln (DE); Axel Ingendoh, Odenthal (DE); Ulrich Schnegg, Leverkusen (DE)

Correspondence Address: BAYER CORPORATION, PATENT DEPARTMENT, 100 BAYER ROAD, PITTSBURGH, PA, 15205, US

(21) Appl. No.: 09/898,709

(22) Filed: Jul. 5, 2001

(30) Foreign Application Priority Data
Jul. 11, 2000 (DE) 10033585.3

(51) Int. Cl. C08F 2/00

(52) U.S. Cl. 521/33

(57) ABSTRACT

The present invention relates to a process for preparing strongly acidic macroporous or strongly acidic monodisperse-gel-type ion exchangers, particularly macroporous monodisperse, macroporous heterodisperse, or monodisperse-gel-type cation exchangers, by treating the respective basis polymer with sulfuric acid in stepwise cycles at graded concentrations. The invention further relates to the cation exchangers prepared by this process and to their uses.

### BACKGROUND OF THE INVENTION

The present invention relates to a process for preparing strongly acidic macroporous ion exchangers or strongly acidic monodisperse-gel-type ion exchangers, particularly macroporous monodisperse ion exchangers, macroporous heterodisperse ion exchangers, or monodisperse-gel-type ion exchangers, by sulfonation with sulfuric acid, which is allowed to act upon the polymer in cycles stepwise with decreasing concentration.

EP 868,444 B1 discloses a process for preparing strongly acidic cation exchangers with particle size ≧0.1 mm, carried out without addition of inert chlorine-containing swelling agents and/or of acrylonitrile-based comonomers at temperatures in the range from 125 to 180° C. using 80 to 96% strength sulfuric acid. This process is suitable for sulfonating gel-like or porous bead polymers.

EP 223,569 B1 discloses a process for washing sulfonated cation exchanger resin beads to remove sulfuric acid by adding discrete amounts of aqueous sulfuric acid with decreasing concentration and finally a discrete amount of water through a bed composed of sulfonated cation exchanger resin beads and of concentrated sulfuric acid. However, the sulfonation itself takes place in the presence of a swelling agent, such as methylene chloride or ethylene chloride, and during the dilution steps the temperature at the point of introduction into the bed must not exceed 40° C.

A disadvantage of the sulfonation processes of the prior art is the fact that despite all attempts to increase mechanical stability and exchange capacity, the products can tend to give undesirable leaching due to soluble polymers arising from the production process or formed during use.

DE-A 10 020 534 addresses this problem in the synthesis of monodisperse-gel-type cation exchangers by introducing dry bead polymer into 97.32% strength by weight sulfuric acid at 100° C. in portions, with stirring, over the course of 4 hours, continuing to stir at 120° C. for 6 hours, and finally percolating with sulfuric acid of decreasing concentration, starting at 90% by weight and finishing with pure water, by means of a column but not using time-delayed cycles.

The object of the present invention was to develop a sulfonation process, both for macroporous bead polymers and for monodisperse-gel-form bead polymers, that gives the sulfonated products the increased osmotic and mechanical stability required to meet current standards and at the same time reliably provides high exchange capacity. For the purposes of the present invention, macroporous bead polymers are either macroporous monodisperse bead polymers or macroporous heterodisperse bead polymers. After sulfonation, the products are macroporous monodisperse or macroporous heterodisperse strongly acidic cation exchangers. The monodisperse-gel-type bead polymers give monodisperse-gel-type cation exchangers.

### SUMMARY OF THE INVENTION

The invention therefore provides a sulfonation process for preparing macroporous or monodisperse-gel-type cation exchangers comprising

(a) feeding a macroporous or monodisperse-gel-type bead polymer, without swelling agents, into sulfuric acid at temperatures of from 110° C. to 140° C.,

(b) stirring the sulfuric-acid-treated bead polymer at a temperature of 110° C. to 140° C. until complete sulfonation takes place,

(c) subjecting the sulfonated bead polymer to cycles of stepwise dilution with sulfuric acids of decreasing concentration, and

(d) washing the bead polymer with demineralized water.

Where appropriate, after step (d) the resin is converted from the acidic H form into a salt form, in an additional step (e).

### DETAILED DESCRIPTION OF THE INVENTION

In one preferred embodiment, the process of the invention can be operated in a process-controlled system, where the stepwise dilution with sulfuric acid of decreasing concentrations and the waiting times required by the cycles are controlled by computer programs.

The process leads to strongly acidic, macroporous, monodisperse or strongly acidic, macroporous, heterodisperse or monodisperse-gel-type cation exchangers that have particularly high mechanical and osmotic stability and also reliably provide high exchange capacity.

The number of defects apparent in the beads of the ion exchangers is extremely small, even after prolonged use and repeated regeneration, and the amount of leaching from the exchanger is reduced compared with prior art products.

Due to their stability and purity, which are markedly increased with respect to the prior art, and particularly due to increased stability with regard to oxidation, the cation exchangers according to the present invention are particularly suitable for treating drinking water, for the preparation of ultrahigh-purity water, for the chromatographic separation of sugars, such as glucose and fructose, and also as catalysts for chemical reactions, for example, in condensation reactions, addition reactions, transesterifications, or alkylation reactions.

The present invention therefore also provides the strongly acidic, macroporous cation exchangers, either in monodisperse or else in heterodisperse form, and monodisperse-gel-type cation exchangers, prepared according to the process of the invention, and also the use of these to treat drinking water, to prepare ultra-high-purity water, to separate sugars chromatographically, or as catalysts for chemical reactions, for example, in condensation reactions, addition reactions, transesterifications, or alkylation reactions.

The present invention therefore also provides strongly acidic, macroporous cation exchangers, either in monodisperse form or in heterodisperse form, and also provides monodisperse-gel-type cation exchangers, these being prepared by the process of the invention, and also provides their use for treating drinking water, for preparing ultra-high-purity water, for separating sugars by chromatography, or as catalysts in condensation reactions, addition reactions, transesterifications, or alkylation reactions.

The strongly acidic, macroporous cation exchangers of the invention and the monodisperse-gel-type cation exchangers have excellent suitability for use in the electronics industry in computer chip production, in the food and drink industry, particularly the sugar industry, or as catalysts in the chemical industry.

The strongly acidic macroporous cation exchangers prepared according to the invention have pore size ranges of 10 nm and above.

Starting materials in step (a) of the process of the invention are monodisperse macroporous or heterodisperse macroporous bead polymers or monodisperse-gel-type bead polymers (basis polymer). These starting materials are composed of crosslinked polymers of singly ethylenically unsaturated monomers composed mainly of at least one compound from the series styrene, vinyltoluene, ethyl styrene, or α-methylstyrene, or ring-halogenated derivatives thereof, such as chlorostyrene. In addition, the starting materials may also contain one or more compounds from the series vinylbenzyl chloride, acrylic acid, its salts and its esters, particularly its methyl ester, and also vinyinaphthalenes, vinylxylenes, or the nitriles or amides of acrylic or methacrylic acids.

The polymers have been crosslinked—preferably by copolymerization with crosslinking monomers having more than one copolymerizable C═C double bond (preferably having 2 or 3 C═C copolymerizable double bonds) per molecule. Examples of crosslinking monomers of this type encompass polyfunctional vinyl aromatics, such as di- or trivinylbenzenes, divinylethylbenzene, divinyltoluene, divinylxylene, divinylethylbenzene, or divinyinaphthalene; polyfunctional allylaromatics, such as di- or triallylbenzenes; polyfunctional vinyl- or allylheterocycles, such as trivinyl or triallyl cyanurate or isocyanurate; N,N′-C₁-C₆-alkylene-diacrylamides or -dimethacrylamides, such as N,N′-methylenediacrylamide or -dimethacrylamide, N,N′-ethylendiacrylamide or -dimethacrylamide; polyvinyl or polyallyl ethers of saturated C₂-C₂₀ polyols having from 2 to 4 OH groups per molecule, e.g., ethylene glycol divinyl or diallyl ether or diethylene glycol divinyl or diallyl ether; esters of unsaturated C₃-C₁₂ alcohols or of saturated C₂-C₂₀ polyols having from 2 to 4 OH groups per molecule, such as allyl methacrylate, ethylene glycol di(meth)acrylate, glycerol tri(meth)acrylate, or pentaerythritol tetra(meth)acrylate; divinyl-ethyleneurea; divinylpropyleneurea; divinyl adipate; or aliphatic or cycloaliphatic olefins having 2 or 3 isolated C═C double bonds, such as 1,5-hexadiene, 2,5-dimethyl-1,5-hexadiene, 1,7-octadiene, or 1,2,4-tri-vinylcyclohexane. Crosslinking monomers that have proven particularly useful are divinylbenzene (in the form of an isomer mixture) and mixtures of divinyl benzene and aliphatic C₆-C₁₂ hydrocarbons having 2 or 3 C═C double bonds. The amounts generally used of the crosslinking monomers are from 1 to 80% by weight (preferably from 2 to 25% by weight), based on the total amount of the polymerizable monomers used.

The crosslinking monomers do not have to be used in pure form but may also be used in the form of their industrially available lower-purity mixtures (e.g., divinylbenzene in a mixture with ethylstyrene).

The copolymerization of monomer and crosslinker is usually initiated by free-radical generators that are monomer-soluble. Examples of preferred free-radical-generating catalysts encompass diacyl peroxides, such as diacetyl peroxide, dibenzoyl peroxide, di-p-chlorobenzoyl peroxide, or lauroyl peroxide; peroxyesters, such as tert-butyl peroxyacetate, tert-butyl peroctoate, tert-butyl peroxypivalate, tert-butyl peroxy-2-ethylhexanoate, tert-butyl peroxybenzoate, or dicyclohexyl peroxydicarbonate; alkyl peroxides, such as bis(tert-butylperoxy)butane, dicumyl peroxide, or tert-butyl cumyl peroxide; hydroperoxides, such as cumene hydroperoxide or tert-butyl hydroperoxide; ketone peroxides, such as cyclohexanone hydroperoxide, methyl ethyl ketone hydroperoxide, or acetylacetone peroxide; or, preferably, azoisobutyrodinitrile.

The free-radical generators may be used in catalytic amounts, i.e., preferably from 0.01 to 2.5% by weight (particularly from 0.12 to 1.5% by weight), based on the total of monomer and crosslinker.

The crosslinked basis polymers may be prepared by known methods of suspension polymerization; cf. Ullmann's Encyclopedia of Industrial Chemistry, 5th edition, Vol. A21, 363-373, VCH Verlags-gesellschaft mbH, Weinheim 1992. The water-insoluble monomer/cross-linker mixture is added to an aqueous phase that preferably comprises at least one protective colloid for stabilization of the monomer/crosslinker droplets in the disperse phase and of the bead polymers produced therefrom. Natural or synthetic water-soluble polymers are suitable as protective colloids, e.g., gelatin, starch, polyvinyl alcohol, polyvinyl-pyrrolidone, polyacrylic acid, polymethacrylic acid, or copolymers made from (meth)acrylic acid or from (meth)acrylic esters. Cellulose derivatives are also highly suitable, particularly cellulose ethers or cellulose esters, such as methylhydroxyethylcellulose, methylhydroxypropylcellulose, hydroxyethylcellulose, or carboxymethylcellulose. The amount of the protective colloids used is generally from 0.02 to 1% by weight (preferably from 0.05 to 0.3% by weight), based on the aqueous phase.

The aqueous phase/organic phase weight ratio is preferably in the range from 0.5 to 20, particularly from 0.75 to 5.

In one particular embodiment, the basis polymers are prepared in the presence of a buffer system during the polymerization. Preference is given to buffer systems that set the pH of the aqueous phase at the start of the polymerization to a value between 14 and 6 (preferably between 12 and 8). Under these conditions, protective colloids having carboxylic acid groups are present to some extent or entirely in salt form. This has a favorable effect on the action of the protective colloids. The concentration of buffer in the aqueous phase is preferably from 0.5 to 500 mmol per liter (particularly from 2.5 to 100 mmol per liter) of aqueous phase.

The organic phase may be distributed in the aqueous phase by stirring, and the particle size of the resultant droplets here then depends substantially on the stirring rate. If it is desired that the basis polymers have a very uniform particle size (generally described as “monodisperse”), preference should be given to processes suitable for this purpose. To this end, the monomer stream may be injected into the aqueous phase, in which case the production of droplets of uniform size, without coales-cence, is reliably provided by vibration-induced breakdown of the jet and/or by microencapsulation of the resultant monomer droplets (EP 46,535 B1 and EP 51,210 B1).

So that the basis polymers retain the macroporous structure, porogens, as described by way of example in Seidl et al., Adv. Polym. Sci., Vol. 5 (1967), pp. 113 to 213, are added to the monomer/crosslinker mixture, e.g., aliphatic hydrocarbons, alcohols, esters, ethers, ketones, trialkylamines, nitro compounds, preferably isododecane, isodecane, methyl isobutyl ketone, or methyl isobutyl carbinol, in amounts of from 1 to 150% by weight (preferably from 40 to 100% by weight, particularly from 50 to 80% by weight), based on the total of monomer and crosslinker.

The polymerization temperature depends on the decomposition temperature of the initiator used. It is generally from 50 to 150° C., preferably from 55 to 100° C. The polymerization time is from 0.5 hour to a few hours. It has proved useful to employ a temperature program in which the polymerization begins at low temperature (e.g. 60° C.) and the reaction temperature is raised as conversion in the polymerization progresses.

The resultant bead polymers may be passed to the functionalization process as they stand or else with enlarged particle size by way of an intermediate stage that can be approached by what is known as a seed/feed process. The process steps of this seed/feed process comprise using copolymerizable monomers (“feed”) to initiate swelling of the polymer initially obtained (“seed”) and polymerizing the monomer that has penetrated into the polymer. Examples of suitable seed/feed processes are described in EP 98,130 B1 and EP 101,943 B1.

Substances that are monodisperse for the purposes of the present application are those in which the diameter of at least 90% of the particles, by volume or by weight, varies from the most frequent diameter by not more than ±10% of the most frequent diameter. For example, in the case of a bead polymer for which the most frequent bead diameter is 0.50 mm, at least 90%, by volume or by weight, lie in the size range from 0.45 to 0.55 mm, and in the case of a bead polymer for which the most frequent bead diameter is 0.70 mm, at least 90%, by weight or by volume, lie within the size range from 0.77 to 0.63 mm.

For the purposes of the present application, bead polymers outside this definition are termed heterodisperse.

Heterodisperse macroporous basis polymers may be prepared as in U.S. Pat. No. 3,716,482 or U.S. Pat. No. 3,637,535, for example.

Monodisperse basis polymers are obtained by screening of heterodisperse bead polymers or they are directly obtained from the manufacturing process, such as jetting, seed/feed, or direct atomization. These processes are for example described in U.S. Pat. Nos. 3,922,255, 4,444,961, and 4,427,794.

Monodisperse-gel-type basis polymers may be prepared as in DE-A19 852 667 or DE-A 10 020 534, for example.

A decisive factor in relation to the sulfonation process of the invention is that process step (a) is carried out without swelling agents, at temperatures of from 110 to 140° C., preferably from 115 to 120° C.

The sulfuric acid to be used in process step (a) preferably has a concentration in the range from 92 to 100%, particularly preferably from 92.5 to 99%. It is preferable for the basis polymer to be fed into the sulfuric acid with stirring.

The process of the invention may be carried out either in the presence or else in the absence of air or oxygen. If it is operated in the absence of air or oxygen, it is advisable to use inert gas, particularly nitrogen.

The continued stirring in process step (b) takes place until the sulfonation of the macroporous or gel-type bead polymer has been completed. During this process the sulfonation temperature from process step (a) is retained, and the degree of sulfonation is monitored by visual assessment of the beads under a microscope. The sulfonation proceeds from the exterior of the bead to the interior of the bead (core). The sulfonation front is apparent during the process from the development of rings within the beads. When the sulfonation is complete, the rings have disappeared from the beads, which are visually uniform and structureless.

In process step (c) the stepwise dilution in cycles takes place at graded concentrations using sulfuric acids of decreasing concentration.

Where appropriate, for process step (c) the suspension of the sulfonated polymer is transferred into a column, preferably into a glass column.

At the start of the stepwise dilution in cycles, or at the moment of transfer into a column, the concentrated sulfuric acid may have a concentration of 90% by weight or more, for example, and the bed in the column, made from sulfonated cation exchanger resin and from concentrated sulfuric acid can, for example, be the mixture produced from non-functionalized resin during the sulfonation of the beads. In one embodiment of the invention, the washing of the sulfonated macroporous bead polymer now takes place stepwise in cycles, in each case using a discrete amount (known as a batch) of aqueous sulfuric acids, and proceeding from the upper end of the column through the bed. If the initial concentration of the sulfuric acid is 90% by weight, the batches are composed, for example, of graded concentrations of aqueous sulfuric acids, such as 88% by weight, 75% by weight, 65% by weight, 35% by weight, and 15% by weight, since concentrations of these types when passed through a bed comprising 90% strength by weight sulfuric acid give concentrations that can be used, for example, for recirculating.

During the dilution in cycles, the bead polymer initially present in concentrated sulfuric acid is converted into its hydrated state. The stepwise hydration is associated with an increase in the volume of the beads.

During this process the beads are also purified. The sulfuric acid eluted carries with it contamination, such as soluble polystyrenesulfonic acids. The emission of contamination from the bead interiors is substantially diffusion-controlled. The alternating cycles of filtration and cessation of filtration that occur during the timed cycles of dilution promote the discharge of contamination from the bead interiors by diffusion and the removal of this contamination from the column.

The batches to be passed downward through the resin bed preferably have sulfuric acid concentrations in the range from 90 to 70% by weight, 70 to 55% by weight, 55 to 40% by weight, 40 to 30% by weight, and finally below 20% by weight. The number of batches depends on respective requirements and can vary from charge to charge. The concentration ranges mentioned are examples but the values specified therein are non-limiting.

For the purposes of the present invention, the significance of the expression “in cycles” is as follows: For a time x, sulfuric acid of reducing concentration is percolated through the sulfonated resin. After a time x has elapsed, the filtration is stopped for a time y. The resin remains in the column. After expiry of the time y, the filtration of the sulfuric acid is continued. This procedure is repeated up to 10 times. Finally, water is used for rinsing until the water eluted from the resin has a pH of about 5. About 6 hours are needed for the entire process of dilution in cycles. The times x and y may be freely selected within the overall limits, x being greater than y.

In order for the washing procedure carried out on the sulfonated bead polymer to be as non-aggressive as possible for the resin beads, it is advisable to carry out the batchwise dilution at temperatures of from 60 to 100° C., preferably from 65 to 950° C.

After passing through the column with the sulfonated bead polymer, the individual batches may be collected and recirculated, i.e. reused.

Without adopting any particular theory, it is assumed that the density difference between adjacent batches of aqueous sulfuric acid of different concentrations can give rise to “plug flow” when the discrete amounts of aqueous sulfuric acid of reducing concentration are passed downward through the bed. This would imply that no very great mixing takes place at the interface between two adjacent discrete amounts of sulfuric acid of different concentrations. This situation can be further improved by careful selection of the flow conditions.

In process step (c), the manner in which the equilibrium between the aqueous sulfuric acid passed downward through the bed and the sulfonated resin in the bed acts upon the water present in the aqueous sulfuric acid is such that a given discrete amount of aqueous sulfuric acid generally has a higher sulfuric acid concentration on discharge from the bed than on introduction into the bed. These factors mean that almost all of the sulfuric acid discharged from the bed has a concentration sufficiently high that it can be used either in the form of the individual fractions directly obtained with a different, specific sulfuric acid concentration or after mixing of two of more fractions to give sulfuric acid of a desired concentration for washing further resin. As an alternative to this, sulfuric acid of this type may also be used in other chemical processes or sold.

Since the mixing taking place in the boundary region between the lowest-concentration sulfuric acid and the water passed through the bed is reduced to a minimum and since the highly dilute aqueous sulfuric acid arising through mixing in this boundary region may have to be consigned to waste, the total amount of sulfuric acid to be consigned to waste is also reduced to a minimum.

Besides the very small amount of waste sulfuric acid, the process of the invention for sulfonating macroporous bead polymers also has the following other advantages:

1. Due to the very small amount of waste sulfuric acid, the amount of neutralizing agent required for neutralization (for example, lime or sodium hydroxide) is also reduced to a minimum.

2. Careful selection of concentration levels in the sulfuric acid batches substantially reduces the amounts of a aqueous sulfuric acid needed in the process of the invention compared with that needed in known batch hydration processes.

3. The selected temperature range reduces the thermal shock experienced by the resin beads in the process of the invention and thus reduces the probability of breakdown of the resin beads when comparison is made with the known hydration processes.

4. The process of the invention can prepare macroporous monodisperse and macroporous heterodisperse, or else monodisperse-gel-type, cation exchangers, without addition of inert swelling agents, their leaching behavior being better than that given by conventional sulfonation processes, and their mechanical and osmotic stability being particularly high, and their exchange capacity and purity being high.

They therefore fulfil the high requirements placed upon modern catalysts for chemical reactions of the above-mentioned type, and also those for preparing ultra-high-purity water for the electronics industry or chip industry.

The volume of each discrete amount of aqueous sulfuric acid that is passed through the bed may be from 0.75 to 2.0 l/kg of resin within the bed, for example. The volume of the discrete amount of water passed through the resin-containing bed may be from 3 to 4 l/kg of resin within the bed, for example.

The through-flow rate for each discrete amount of aqueous sulfuric acid and/or for the discrete amount of water through the resin-containing bed is from 2 to 4 l/kg of resin.

The latent heat of dilution generated during the dilution step (c) is kept low, for example by appropriate choice of the concentrations of the aqueous sulfuric acid. No equipment for cooling the column is required. In addition, the expansion of the resin which occurs during the process of the invention due to the treatment with aqueous sulfuric acid and water may readily be provided for by producing a pulse-type backflow of the discharge stream through the resin bed.

Finally, in process step (d) the washing of the sulfonated macroporous bead polymer takes place with demineralized water, preferably at a temperature in the range from 60 to 100° C., particularly preferably in the range from 70 to 95° C. Washing with demineralized water is continued until the water eluted from the bed at the base of the column has a pH above 5.

Where appropriate, following process step (d), it is possible to carry out process step (e), the conversion of the sulfonated macroporous bead polymer from the H form into the salt form. The conversion into the salt form, preferably the sodium form, takes place via addition of alkali metal hydroxide solution of from 10 to 60% strength by weight (preferably from 10 to 60% strength by weight) sodium hydroxide solution.

In one preferred embodiment, the conversion is carried out in a temperature range from 60 to 120° C., in particular from 65 to 100° C.

The macroporous monodisperse, macroporous heterodisperse and monodispersed-gel-type ion exchangers prepared according to the sulfonization process of the invention with its cycles are highly suitable as catalysts for condensation reactions, for addition reactions, such as those of alcohols onto alkenes to give ethers, as catalysts in esterification or transesterification reactions, or as catalysts in alkylation reactions.

The low usage of sulfuric acid makes the ion exchangers prepared according to the sulfonation process of the invention suitable for treating drinking water, for purifying and treating water in the chemical, electrical, or electronics industry, for preparing printed circuit boards, or for use in the chip industry, particularly for preparing ultra-high-purity water, or for chromatographic separation of sugars, i.e., in the food and drink industry.

The cation exchangers obtained by the sulfonation process according to the present invention are furthermore suitable

for the removal of cations, colorant particles or organic components from aqueous or organic solutions and condensates, such as, for example, process or turbine condensates,

for softening of aqueous or organic solutions and condensates, such as, for example, process or turbine condensates in neutral exchange,

for the purification and treatment of water in the chemical industry, the electronics industry, and from power stations,

for the demineralization of aqueous solutions and/or condensates, such as, for example, process or turbine condensates,

in combination with heterodisperse or monodisperse, gelatinous and/or macroporous anion exchangers, for the demineralization of aqueous solutions and/or condensates, such as, for example, process or turbine condensates, and

for the decolorization and desalination of whey, gelatin solutions, fruit juices, fruit musts, and aqueous solutions of sugars.

Consequently, the invention likewise relates to

A process for the removal of cations, colorant particles, or organic components from aqueous or organic solutions and condensates, such as, for example, process or turbine condensates, using the cation exchangers obtained by the presently claimed sulfonation process.

A process for the softening of aqueous or organic solutions and condensates, such as, for example, process or turbine condensates, in neutral exchange using the cation exchangers obtained by the presently claimed sulfonation process.

A process for the purification and treatment of water in the chemical industry, the electronics industry, and from stations using the cation exchangers obtained by the presently claimed sulfonation process.

A process for the demineralization of aqueous solutions and/or condensates such as, for example, process or turbine condensates, using the cation exchangers obtained by the presently claimed sulfonation process in combination with heterodisperse or monodisperse, gelatinous and/or macroporous anion exchangers

A process for the decolorization and desalination of whey, gelatin solutions, fruit juices, fruit musts, and aqueous solutions of sugars in the sugar, starch, or pharmaceuticals industries or dairies using the cation exchangers obtained by the sulfonation process of the present invention.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

Experimental Methods

Determination of Conductivity of the Water Eluted from the Resin

100 ml of cation exchanger in the H form were slurried in demineralized water and placed in a glass column (length 30 cm, diameter 2 cm). The supernatant water above the resin was run off. Deionized water at 70° C. was then percolated through the resin at a rate of 0.2 bed volumes per hour. The electrical conductivity of the eluate water, cooled to 20° C., was measured after running off 2 and 4 bed volumes of water.

Determination of Resin Stability by the Roll Test

The bead polymer to be tested was distributed at a uniform layer thickness between two cloths made of synthetic material. The cloths were laid on a firm horizontal substrate and subjected to 20 operating cycles in a roll apparatus. An operating cycle was composed of one pass and return pass of the roll. After rolling, representative samples of 100 beads were taken and the number of undamaged beads counted under a microscope.

### Example 1

Example of a Sulfonation with Conventional Dilution

1,800 ml of 94.4% strength by weight sulfuric acid was metered into a laboratory reactor. The sulfuric acid was heated to 80° C. Then, at intervals of 20 minutes, 6 portions each of 75 g of macroporous monodisperse bead polymer were metered in. The mixture was then heated to 115° C. over a period of 60 minutes. Stirring was continued for 6 hours at 115° C.

The suspension was poured into a column, and sulfuric acid at reducing concentration was percolated through the column, but not in cycles, beginning with a concentration of 90% by weight and finishing with pure water—as described in DE-A 10 020 534.

The total amount of 100% strength by weight sulfuric acid needed for the entire dilution process was 1,899 g.

Yield of sulfonated hydrated resin: 2 410 ml

### Example 2

Example of Sulfonation with Cycles of Dilution According to the Present Invention

The sulfonation itself was carried out as described in Example 1.

The suspension was then poured into a column, which was temperature-controlled to 90° C.

250 ml of 80% strength by weight sulfuric acid were percolated through the resin over the course of 1 hour. The percolation and the discharge of acid were then stopped for one hour. 250 ml of 65% strength by weight sulfuric acid were then percolated through the resin over the course of 1 hour. The percolation and the discharge of acid were then stopped for one hour. 250 ml of 35% strength by weight sulfuric acid were then percolated through the resin over the course of 1 hour. The percolation and the discharge of acid were then stopped for one hour. 100 ml of 15% strength by weight sulfuric acid were percolated through the resin over the course of 1 hour. The percolation and the discharge of acid were then stopped for one hour. Finally, the resin in the column was washed with demineralized water until the water eluted at the base of the column had a pH above 5.

The total amount of 100% strength by weight sulfuric acid needed for the entire dilution process was 727 g.

Yield of sulfonated hydrated resin: 2,420 ml

| | Conductivity of water | |
|---|---|---|
| | eluted from resin after | Resin stability from |
| Cycled dilution of | percolation of 2 and 4 bed | the roll test: number |
| sulfonated resin | volumes, respectively | of perfect beads in |
| (yes/no) | (μS/cm) | 100 |
| yes (in accordance | 26/16 | 94 |
| with Example 2) | | |
| no (in accordance | 50/40 | 88 |
| with Example 1) | | |

Surprisingly, the stepwise sulfonation process of the invention with its cycles consumed markedly less sulfuric acid than when the sulfonation process was carried out without cycles and, moreover, gave very much lower conductivity of the water eluted from the resin, both after 2 bed volumes of water and after 4 bed volumes of water and also gave an increased proportion of perfect beads.

What is claimed is:

1. A sulfonation process for preparing macroporous or monodisperse-gel-type cation exchangers comprising
(a) feeding a macroporous or monodisperse-gel-type bead polymer, without swelling agents, into sulfuric acid at temperatures of from 110° C. to 140° C.,
(b) stirring the sulfuric-acid-treated bead polymer at a temperature of 110° C. to 140° C. until complete sulfonation takes place,
(c) subjecting the sulfonated bead polymer to cycles of stepwise dilution with sulfuric acids of decreasing concentration, and
(d) washing the bead polymer with demineralized water.

2. A process according to claim 1 wherein process step (c) is carried out in the temperature range from 60° C. to 110° C.

3. A process according to claim 1 wherein the sulfuric acid in process step (a) has a concentration in the range from 92 to 100% by weight.

4. A process according to claim 1 wherein the water in process step (d) has a temperature in the range from 60° C. to 100° C.

5. A process according to claim 1 wherein the cycles of stepwise dilution in process step (c) are carried out using sulfuric acid concentrations in the ranges from 90 to 70% by weight, 70 to 55% by weight, 55 to 40% by weight, 40 to 30% by weight, and below 20% by weight.

6. A process according to claim 1 wherein a macroporous polymer is fed in portions into the sulfuric acid.

7. A process according to claim 1 wherein process step (b) is carried out at the temperature of process step (a) until completion of sulfonation.

8. A process according to claim 1 additionally comprising
(e) converting the sulfonated macroporous bead polymer or the sulfonated monodisperse-gel-type bead polymer from step (d) from the H form into a salt form.

9. A macroporous or monodisperse-gel-type cation exchanger in the H form obtained according to claim 1.

10. A macroporous or monodisperse-gel-type cation exchanger in the sodium form obtained by converting a cation exchanger according to claim 9 using sodium hydroxide solution having a concentration of from 10 to 60% by weight.

11. A method for treating drinking water, preparing ultra-high-purity water, or treating water in the chemical industry, the electrical, the micro-electronics industry, or the chip industry comprising exposing the water to a cation exchanger according to claim 9.

12. A method for treating drinking water, preparing ultra-high-purity water, or treating water in the chemical industry, the electrical, the micro-electronics industry, or the chip industry comprising exposing the water to a cation exchanger in sodium form according to claim 10.

13. A method for separating sugars chromatographically comprising passing the sugars through a chromatographic system containing a cation exchanger according to claim 9.

14. A method for separating sugars chromatographically comprising passing the sugars through a chromatographic system containing a cation exchanger in sodium form according to claim 10.

15. A method for catalyzing a chemical reaction comprising exposing chemicals to a cation exchanger according to claim 9 as catalyst.

16. A method according to claim 15 wherein the chemical reaction is a condensation reaction, addition reaction, transesterification, or alkylation reaction.

17. A method for catalyzing a chemical reaction comprising exposing chemicals to a cation exchanger in sodium form according to claim 10 as catalyst.

18. A method according to claim 17 wherein the chemical reaction is a condensation reaction, addition reaction, transesterification, or alkylation reaction.

19. A process according to claim 1 carried out in a process-controlled system.
